(19) United States
(12) Patent Application Publication
(10) Pub. No.: US 2026/0014730 A1
(43) Pub. Date: Jan. 15, 2026

(54) METHOD FOR SLICING FOOD PRODUCTS AND SLICING MACHINE

(71) Applicant: MULTIVAC SEPP HAGGENMÜLLER SE & CO. KG, Wolfertschwenden (DE)

(72) Inventor: Kai EISENACH, Wolfertschwenden (DE)

(73) Assignee: MULTIVAC SEPP HAGGENMÜLLER SE & CO. KG, Wolfertschwenden (DE)

(21) Appl. No.: 19/266,824

(22) Filed: Jul. 11, 2025

(30) Foreign Application Priority Data
Jul. 12, 2024 (DE) 102024119881.8

(51) Int. Cl. B26D 7/28; B26D 1/28; B26D 3/16; B26D 7/01

(52) U.S. Cl. CPC B26D 7/28; B26D 1/285; B26D 3/166; B26D 7/01; B26D 2007/013; B26D 2210/02

(57) ABSTRACT

The disclosure relates to a method for slicing food products using a slicing machine, including: arranging at least one product calibre on a feeding unit of the slicing machine, feeding, by the feeding unit, the at least one product calibre along a feeding direction to a cutting device of the slicing machine, and slicing, by the cutting device, the at least one product calibre into slices to form portions. Each portion comprises one or more slices, with the at least one product calibre being sliced at least in sections with a preset slice thickness, but at most up to a preset end-piece length. Immediately before the end of slicing the product calibre, one or more final slices are sliced with a reduced slice thickness or an enlarged slice thickness, with the reduced slice thickness and/or the enlarged slice thickness being determined, in particular by a control unit of the slicing machine, in such a way that the at least one product calibre is sliced essentially, preferably exactly, up to the preset end-piece length.

### CROSS-REFERENCE TO RELATED APPLICATIONS

This application claims foreign priority benefits under 35 U.S.C. § 119 (a)-(d) to German patent application number DE 102024119881.8, filed Jul. 12, 2024, which is incorporated by reference in its entirety.

### SUMMARY

The disclosure relates to a method for slicing food products using a slicing machine, comprising the following steps: arranging at least one product calibre on a feeding unit of the slicing machine, feeding, by means of the feeding unit, the at least one product calibre along a feeding direction to a cutting device of the slicing machine, and slicing, by means of the cutting device, the at least one product calibre into slices to form portions, wherein each portion comprises one or more slices, and wherein the at least one product calibre is sliced at least in sections with a preset slice thickness, but at most up to a preset residual length. The disclosure further relates to a slicing machine.

At this point, it should be noted that the process and/or the slicing machine is intended, according to the disclosure, for slicing food in the form of so-called product calibres (e.g., elongated products) into slices, from which portions, preferably shingled, stacked, or slice-folded, can be formed. The product calibres can, for example, be formed from sausage, cheese, cultivated meat, pressed meat and so on. The feeding unit can, for example, be designed as an endlessly circulating conveyor belt or similar. Preferably, the cutting device is arranged downstream of the feeding unit with respect to the feeding direction. The cutting device may include a knife, preferably a sickle knife, which can be driven to rotate around an axis of rotation, for example, by means of an electric drive unit. By means of the knife, the slices can be separated from an end of a respective product calibre facing the cutting device.

Since the product calibres are typically held at their end opposite the cutting device during slicing, for example, by means of a respective gripper, a respective product calibre can only be sliced up to a preset minimum end-piece length. Otherwise, the cutting device could collide with the respective gripper and/or the end-piece could be uncontrollably removed from the respective gripper. The preset minimum end-piece length can also be referred to simply as the preset end-piece length or as the mechanical end-piece length.

If it turns out immediately before the end of slicing a respective product calibre that a length exceeding the preset end-piece length is not sufficient to slice another slice or portion, the slicing of this product calibre is usually immediately terminated and the end-piece is removed, even though it still exceeds the preset end-piece length. This results in the reduction of the yield, which not only leads to economic disadvantages but also encounters decreasing acceptance with regard to aspects of sustainability.

It is therefore an object of the disclosure to provide a remedy, in particular by providing a method in which at least one product calibre, after being cut, has a length that exceeds the preset end-piece length as little as possible or ideally not at all. Furthermore, it is the task of the disclosure to provide a corresponding slicing machine.

This object is solved according to the disclosure by a method of the initially mentioned type, in which immediately before the end of slicing the at least one product calibre, one or more final slices with a reduced slice thickness, which is less than the preset slice thickness, or an enlarged slice thickness, which is greater than the preset slice thickness, are sliced, wherein the reduced slice thickness and/or the enlarged slice thickness are determined, particularly by means of a control unit of the slicing machine, in such a way that the at least one product calibre is essentially, preferably exactly, sliced down to the preset end-piece length.

As the disclosure provides for the slicing of the one or more last slices with the reduced or enlarged slice thickness before the end, i.e., the completion, of the slicing of at least one product calibre, the at least one product calibre can be sliced substantially, preferably exactly, down to the preset end-piece length, thereby maximising what is known as the “yield.” In this context, the term “substantially” can include length deviations from the preset end-piece length up to a level that is not yet of disturbing relevance for the respective application. For example, the length deviation from the preset end-piece length may preferably be smaller than a length corresponding to one slice or more slices cut with the reduced slice thickness or the enlarged slice thickness. It is the merit of the inventor to have recognised that if only one or more last slices of a respective product calibre are cut with the reduced or enlarged slice thickness, while the remaining slices are cut with the preset slice thickness, an average of a slice weight and/or a portion weight of the slices cut from the at least one product calibre is only insignificantly influenced, i.e., reduced or increased. Furthermore, according to the disclosure, it is achieved that the at least one product calibre is substantially completely cut open, i.e., down to the preset end-piece length, and essentially no length beyond this end-piece length remains as an end-piece to be disposed of.

The reduced slice thickness and/or the enlarged slice thickness can preferably be determined by means of a control unit of the slicing machine. Furthermore, all movable parts of the slicing machine can be controlled through the control unit.

To ensure that the slice thickness and consequently the disc weight of one or more of the last discs do not become lower or higher than intended, it is proposed according to one embodiment of the disclosure that the reduced slice thickness and/or the increased slice thickness deviate by at most a preset amount from the preset slice thickness.

In a further development of this exemplary embodiment, the preset amount may be at most 10%, preferably at most 5%, and more preferably approximately 4.5%. The preset amount can generally be in accordance with legal regulations, such as the Prepackaging Regulation (abbreviated: “FPackV”), or other specified requirements. The preset amount can also be determined depending on a tolerance limit for a disc weight of the individual discs and/or a portion weight of the individual portions.

In particular, if a remaining sliceable length of at least one product calibre only slightly falls short of the preset slice thickness, it can be advantageous that, immediately before the end of slicing of at least one product calibre, only the last slice is cut with the reduced slice thickness or enlarged slice thickness.

However, to ensure that each slice cut from at least one product calibre has a slice thickness as close as possible to the preset slice thickness, according to a further embodiment, immediately before the end of slicing at least one product calibre, a final portion, and preferably a penultimate portion, can be cut with the reduced slice thickness or the enlarged slice thickness. Consequently, any remaining sliceable length of at least one product calibre exceeding the length of the remaining piece can be divided into several slices, i.e., the last, and preferably the penultimate portion, so that the deviation from the preset slice thickness for each of the last slices is minimised as much as possible.

According to another embodiment, it is proposed that one or more of the last slices with the reduced slice thickness be cut if an average actual portion weight of a plurality of portions or all portions that have been cut in the past, preferably within the same production batch, is more than a preset amount higher than a preset target portion weight, and/or one or more of the last slices with the enlarged slice thickness be cut if an average actual portion weight of a plurality of portions or all portions that have been cut in the past, preferably within the same production batch, is less than a preset amount higher than a preset target portion weight and/or is equal to or less than a preset target portion weight. This ensures that the so-called “give-away,” i.e., a weight of one or more portions exceeding the preset target portion weight, can be minimised and at the same time ensures that the average actual portion weight of all portions sliced within a production batch comes as close as possible to the preset target portion weight.

If it is determined during the slicing of a production batch that the mean of the actual portion weights at a given point in time is higher than intended, one or more of the last slices can be cut with a reduced slice thickness, so that the last, and optionally the penultimate, portion has a lower actual portion weight in order to approximate the mean to the target portion weight. If, during the slicing of a production batch, it is determined that the average actual portion weights at a given point in time are lower than intended, the one or more last slices can be cut with enlarged slice thickness, so that the last, and optionally the second to last, portion has/have a higher actual portion weight in order to approximate the average to the target portion weight. In addition to or instead of the mean target portion weight, the give-away itself can also be considered, whereby, for example, slicing can be done with enlarged slice thickness if the give-away is less than or equal to a preset value, for example, 0.3%, and/or slicing can be done with enlarged slice thickness if the give-away is greater than or equal to a preset value, for example, 0.3%. Provided that the giveaway is greater than 0, on average only portions that slightly exceed the preset target portion weight will be cut.

Should a case arise in which the remaining sliceable length of at least one product calibre significantly falls short of the preset slice thickness, for example by more than 10% or more than 20%, it is proposed that, if it is determined that the reduced slice thickness deviates by more than the preset amount from the preset slice thickness, no further slices shall be cut from the at least one product calibre.

In principle, it is conceivable to measure a length of at least one product calibre, for example using a length measuring device, particularly the slicing machine, before slicing, and subsequently determine a slice thickness in such a way that the at least one product calibre is completely sliced up to the remaining piece length. In connection with the present disclosure, however, it is proposed that the preset slice thickness is a fixed preset slice thickness, which is preferably determined independently of a length of the at least one product calibre.

Additionally or alternatively, it is conceivable that before cutting, particularly by means of a length measuring unit and/or by means of the feeding unit, a length of the at least one product calibre is determined, and the reduced slice thickness and/or the enlarged slice thickness and/or the number of slices, which are cut with the reduced slice thickness or the enlarged slice thickness, is determined depending on the length. If the length is determined prior to slicing, it can be determined relatively early how many slices can presumably be cut with the preset slice thickness and how many slices can presumably be cut with the reduced or enlarged slice thickness from at least one product calibre. The length measuring unit can be, for example, an optical measuring unit, preferably a scanner, such as an X-ray scanner, or the like. Additionally or alternatively, the length can be determined through the feeding unit by, for example, monitoring a position of a gripper unit. Before cutting and upon a first contact with at least one product calibre using a gripper arranged on the gripper unit, the length can thus be determined, for example, based on a distance of the gripper from a stop, against which the at least one product calibre rests with its end facing away from the gripper.

Additionally or alternatively, during the slicing, particularly by means of a length measuring unit and/or by means of the feeding unit, a remaining sliceable length of the at least one product calibre can be determined, and the reduced slice thickness and/or the enlarged slice thickness and/or the number of slices, which are sliced with the reduced slice thickness or the enlarged slice thickness, are determined depending on the remaining sliceable length. As a result, it is possible to determine only during the slicing process whether and how the reduced slice thickness and/or the enlarged slice thickness should be chosen, and how many slices with reduced slice thickness or enlarged slice thickness should be cut. This can be particularly advantageous when the number of slices that can actually be cut cannot be precisely predicted before slicing due to operational tolerances or other deviations.

According to yet another embodiment, a plurality of product calibres can be arranged on the feeding unit of the slicing machine, the plurality of product calibres being fed substantially simultaneously by means of the feeding unit along the feeding direction to the cutting device and being sliced by means of the cutting device. In this process, preferably for each of the plurality of product calibres, one or more final slices with either the reduced slice thickness or the enlarged slice thickness can be cut, wherein the reduced slice thickness and/or the enlarged slice thickness is determined such that each of the plurality of product calibres is essentially, preferably exactly, cut to the preset leftover piece length. In other words, the method according to the disclosure is also applicable to simultaneously slicing several product calibres, particularly on a multi-track slicing machine. For each of the plurality of product calibres, an individual preset slice thickness and/or an individually reduced or increased slice thickness can be determined.

In accordance with another aspect of the disclosure, the above object is solved by a slicing machine, particularly a slicing machine, for cutting food products, comprising: a feeding unit, which is configured to supply at least one product calibre along a feeding direction, a cutting device, which is configured to cut the at least one product calibre into slices, a portioning unit, which is configured to form portions from the slices cut by the cutting device, where each portion comprises one or more slices, and a control unit, which is configured to control at least the feeding unit, the cutting device, and the portioning unit, wherein the slicing machine is designed and intended to perform the inventive method described above.

With regard to the advantages and effects of the slicing machine according to the disclosure, reference is made to the advantages and effects of the method according to the disclosure. All statements described for the method according to the disclosure also apply to the slicing machine according to the disclosure and vice versa.

According to one embodiment, the slicing machine may further include a length measuring unit, preferably an optical length measuring unit, which is designed to determine a length of the at least one product calibre substantially parallel to the feeding direction before and/or during a slicing operation of the slicing machine. Preferably, at least one signal output of the length measurement unit can be connected to at least one signal input of the control unit.

Furthermore, the slicing machine may preferably further comprise a gripper unit with at least one gripper, wherein the at least one gripper can be configured to grip the at least one product calibre at its end facing away from the cutting device.

In order to further process, particularly package, the portions sliced by the slicing machine, it is additionally or alternatively conceivable that the slicing machine further includes a conveying unit, which is configured to discharge the formed portions along a discharge direction. The conveying unit can, for example, be designed as an insertion unit, which is configured to supply the portions to a packaging machine.

It should also be noted that the slicing machine in connection with the present disclosure can be designed as a single-track or multi-track slicing machine.

### BRIEF DESCRIPTION OF THE DRAWINGS

The disclosure will be further explained below with reference to exemplary embodiments in the accompanying drawings. Figures:

FIG. 1 is a schematic and simplified side view of a slicing machine according to the disclosure according to one embodiment; and

FIG. 2 is a schematic and simplified top view of the slicing machine from FIG. 1.

### DETAILED DESCRIPTION

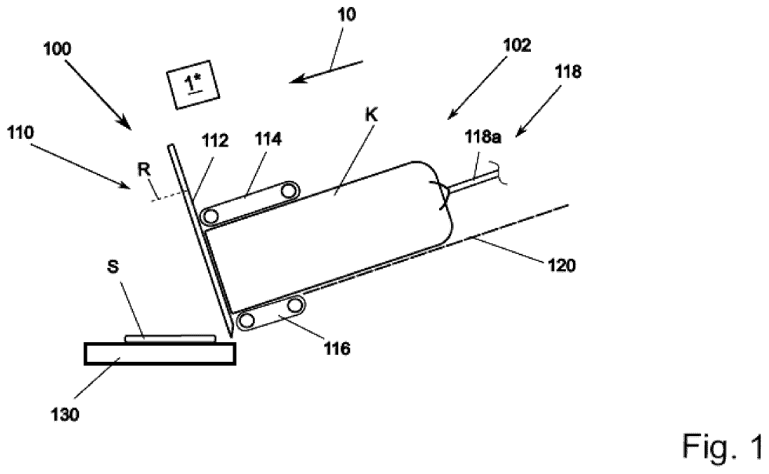

In FIG. 1, a slicing machine according to the disclosure, in accordance with an exemplary embodiment, is generally designated by the reference numeral 100.

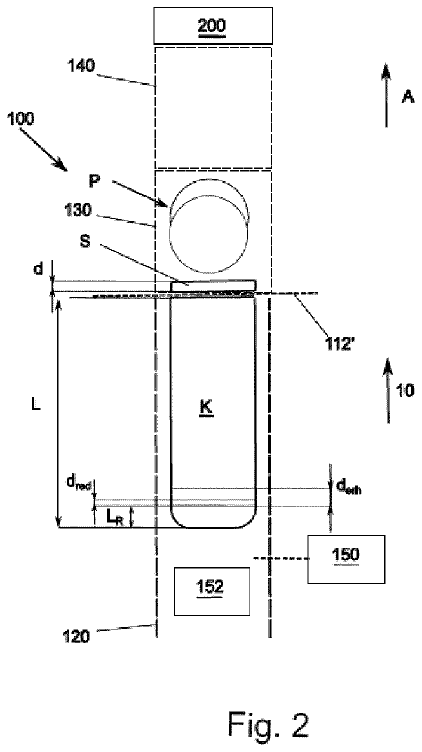

The slicing machine 100 can be designed as either a single-track or multi-track slicing machine and, in the present case, is depicted merely to facilitate the understanding of the disclosure as a single-track slicing machine 100 (see also FIG. 2). The slicing machine 100 comprises a feeding unit 102, which is configured to feed a product calibre K along a feeding direction 10 to a cutting device 110. The cutting device 110 may include a knife or blade 112, which can be driven to rotate about an axis of rotation R, for example, by means of an electric drive unit (not shown). The knife 112 can, for example, be designed as a sickle knife or blade, which preferably has a radius that varies around the axis of rotation R, in particular increasing in the direction of rotation around the axis of rotation R. Consequently, the knife 112 can initially release a cutting gap with a partial rotation around the rotation axis R, allowing the product calibre K to advance in the feeding direction 10, and with a further rotation around the rotation axis R, separate a disc or slice S from the product calibre K.

At a front end, the product calibre K can be guided by an upper traction band 114 and/or a lower traction band 116. The upper traction belt 114 and/or the lower traction belt 116 can be driven separately. However, it is generally sufficient if at least one of the upper traction belt 114 and the lower traction belt 116 is drivable in and preferably opposite to the feeding direction 10. Furthermore, the slicing machine 100 may include a gripper unit 118 with a gripper 118a, which can be configured to grip the product calibre K at its end opposite the cutting device 110.

Before and during the slicing, the product calibre K can rest on a feeder 120, which may be designed as a belt conveyor and is also depicted schematically in FIGS. 1 and 2.

Furthermore, in FIG. 1, a control unit 1* of the slicing machine 100 is schematically indicated, by means of which the cutting device 110, a portioning unit 130 (e.g., such as a portioning conveyor belt), as well as the feeding unit 102 of the slicing machine 100, and preferably all other movable parts of the slicing machine 100, can be controlled. The upper traction band 114, the lower traction band 116, the feeder 120, and the gripper unit 118 can be assigned to the feeding unit 102.

In FIG. 2, where the upper traction band 114 is omitted for clarity, a cutting plane 112′ of the knife 112 is merely schematically indicated by a dashed line. By means of the knife 112, slices S can be cut from the product calibre K through a rotational movement around the rotation axis R and in the cutting plane 112′. The slices S can fall onto the portioning unit 130 after being cut off. For example, by stacking or shingling multiple slices S, respective portions P can be formed on the portioning unit 130. From there, the portions P can be conveyed along a discharge direction A to a conveying unit 140, for example, an insertion unit in the form of a band inserter, which may be configured to supply the portions P to a downstream processing device 200, for example, in the form of a packaging machine, which is also merely schematically indicated in FIG. 2. The conveying unit 140 and the packaging machine 200 are not shown in FIG. 1 for reasons of clarity.

Furthermore, with reference to FIG. 2, it should be noted that although the gripper 118a of the gripper unit 118 is not shown, the product calibre K can nevertheless be held by the gripper 118a.

Since the product calibre K is held by the gripper 118a during slicing by the slicing machine 100, the product calibre K can only be sliced up to a preset minimum end-piece length LR. Otherwise, the blade 112 would collide with the gripper 118a, particularly with its gripper claws penetrating the product calibre K, which could result in an uncontrolled removal of a remaining end-piece from the product calibre K by the gripper 118a.

In principle, the product calibre K can be cut with a preset slice thickness d, which is preferably a fixed preset slice thickness d, preferably determined independently of a length L of the product calibre K. If it turns out immediately before the end of slicing the product calibre K that the length extending beyond the preset end-piece length LR is no longer sufficient to slice an additional slice S or another portion P, then according to the disclosure, one or more final slices S with a reduced slice thickness d_{red}, which is less than the preset slice thickness d, are sliced. The reduced slice thickness d_{red} is preferably determined by the control unit 1* of the slicing machine 100 in such a way that the product calibre K can be sliced essentially, preferably exactly, up to the preset end-piece length LR.

Alternatively, one or more of the last slices S can also be cut with an increased slice thickness dₑᵣₕ, which is greater than the preset slice thickness d. Provided that only one or more of the last slices S of the product calibre K are cut with the reduced slice thickness D_{red} or the enlarged slice thickness Dₑᵣₕ, while the remaining slices S are cut with the preset slice thickness d, an average value of a slice weight and/or a portion weight of the slices S or portions P cut from the product calibre K is only insignificantly affected, i.e., reduced or increased. Furthermore, according to the disclosure, it is achieved that the at least one product calibre K can be cut open essentially completely, i.e., up to the preset residual length LR, and essentially no length beyond this residual length LR remains as waste to be disposed of.

In the simplest case, for example, only the last slice S from the product calibre K can be cut with the reduced or enlarged slice thickness, wherein all slices S from the product calibre K, except for the last slice S, have the preset slice thickness d, but only the last slice S has the reduced slice thickness d_{red} or the enlarged slice thickness dₑᵣₕ.

However, to ensure that each slice S cut from the product calibre K has a slice thickness that comes as close as possible to the preset slice thickness d, a last portion P, and preferably a penultimate portion P, can be cut with the reduced slice thickness d_{red} or the enlarged slice thickness dₑᵣₕ before the end of slicing the product calibre K. Then, a remaining cuttable length of the product calibre K that exceeds the residual length LR can be divided into several slices S, so that the deviation from the preset slice thickness d for each of the last slices S is minimised as much as possible.

Furthermore, one or more of the last slices S with the reduced slice thickness d_{red} may be cut if an average of an actual portion weight of a plurality of portions P or all portions P, which have been cut in the past, preferably within the same production batch, is higher by more than a preset amount than a preset target portion weight. Additionally or alternatively, one or more of the last slices S with the enlarged slice thickness dₑᵣₕ can be cut if an average of an actual portion weight of a plurality of portions P or all portions P, which have been cut in the past, preferably within the same production batch, is less than a preset amount higher than a preset target portion weight and/or is equal to or less than the preset target portion weight. This makes it possible for the so-called “give-away”, i.e. the amount by which the weight of a given portion P exceeds the predetermined target portion weight, to be reduced to a minimum. The weight of a respective portion P can, for example, be determined by means of a weighing unit (not shown), which can preferably be integrated into the portioning unit 130.

If a remaining cuttable length of the product calibre K significantly falls short of the preset slice thickness d, for example by more than 10% or more than 20%, it can be determined by means of the control unit 1* that no further discs or slices S are to be cut from the at least one product calibre K, in order to prevent the formation of reject discs or slices that may not be further usable.

Since in the illustrated embodiment the slicing machine 100 further comprises a length measuring unit 150, the length L of the product calibre K can be determined before slicing, and a probable reduced slice thickness d_{red} and/or a probable enlarged slice thickness dₑᵣₕ and/or a probable number of slices S can be determined using the control unit 1*, which will be sliced with the reduced slice thickness d_{red} or the enlarged slice thickness dₑᵣₕ. Furthermore, even before slicing the product calibre K, it can be determined using the control unit 1* how many slices S are expected to be cut with the preset slice thickness d and how many slices S can be cut with the reduced slice thickness d_{red} or the enlarged slice thickness dₑᵣₕ. The length measuring unit 150 can, for example, be designed as an optical length measuring unit, preferably as a laser and/or an X-ray scanner. Furthermore, a weighing unit 152 can be provided on the feeder 120, in particular integrated into the feeder 120, to determine a weight of the product calibre K, preferably before slicing and/or during slicing.

Additionally or alternatively, it can also be determined during the slicing process using the length measuring unit 150 how large a remaining sliceable length of the product calibre K is, and the reduced slice thickness d_{red} and/or the enlarged slice thickness dₑᵣₕ and/or the number of slices S, which are cut with the reduced slice thickness d_{red} or the enlarged slice thickness dₑᵣₕ, can be determined depending on the remaining sliceable length.

It should also be noted that the method according to the disclosure described above can also be applied to simultaneously slicing a plurality of product calibres K on a multi-track slicing machine. In this context, the reduced slice thickness d_{red} and/or the increased slice thickness dₑᵣₕ can be determined either separately or jointly for each product calibre K on adjacent tracks of the slicing machine.

As one skilled in the art would understand, the control unit 1*, the weighing unit 152, as well as any other control, controller, unit, system, subsystem, sensor, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC).

What is claimed is:

1. A method for slicing food products using a slicing machine, the method comprising:
arranging at least one product calibre on a feeding unit of the slicing machine;
feeding, by the feeding unit, the at least one product calibre along a feeding direction to a cutting device of the slicing machine; and
slicing, by the cutting device, of the at least one product calibre into slices to form portions, where each portion comprises one or more slices, whereby the at least one product calibre is sliced at least in sections with a preset slice thickness, but at most up to a preset end-piece length;
wherein, before an end of slicing the at least one product calibre, one or more last slices with a reduced slice thickness, which is less than the preset slice thickness, or an enlarged slice thickness, which is greater than the preset slice thickness, are sliced, wherein the reduced slice thickness and/or the enlarged slice thickness are/is determined by a control unit of the slicing machine in such a way that the at least one product calibre is sliced down to the preset end-piece length.

2. The method according to claim 1, wherein the reduced slice thickness and/or the enlarged slice thickness deviates from the preset slice thickness by at most a preset amount.

3. The method according to claim 2, wherein the preset amount is at most 10%.

4. The method according to claim 1, wherein the at least one product calibre is sliced down to substantially or exactly the preset end-piece length.

5. The method according to claim 1, wherein, before the end of slicing the at least one product calibre, only a last slice is sliced with the reduced slice thickness or the enlarged slice thickness.

6. The method according to claim 1, wherein, before the end of slicing the at least one product calibre, a last portion is sliced with the reduced slice thickness or the enlarged slice thickness.

7. The method according to claim 1, wherein, before the end of slicing the at least one product calibre, a last portion and a penultimate portion are sliced with the reduced slice thickness or the enlarged slice thickness.

8. The method according to claim 1, wherein
the one or more last slices are cut with the reduced slice thickness if an average of an actual portion weight of a plurality of portions or all portions, which have been sliced in the past, is more than a preset amount higher than a preset target portion weight, or
the one or more last slices are cut with the enlarged slice thickness if an average of an actual portion weight of a plurality of portions or all portions, which have been sliced in the past, is higher by less than a preset amount than the preset target portion weight and/or is equal to or less than the preset target portion weight.

9. The method according to claim 2, wherein, if it is determined that the reduced slice thickness deviates by more than the preset amount from the preset slice thickness, no further slices of the at least one product calibre will be sliced.

10. The method according to claim 1, wherein the preset slice thickness is a fixed preset slice thickness, which is determined independently of a length of at least one product calibre.

11. The method according to claim 1, wherein before the slicing, a length of at least one product calibre is determined, and the reduced slice thickness and/or the enlarged slice thickness and/or number of slices, which are sliced with the reduced slice thickness or the enlarged slice thickness, are/is determined depending on the length.

12. The method according to claim 1, wherein during the slicing, a remaining sliceable length of at least one product calibre is determined, and the reduced slice thickness and/or the enlarged slice thickness and/or number of slices, which are sliced with the reduced slice thickness or the enlarged slice thickness, are/is determined depending on the remaining sliceable length.

13. The method according to claim 1, wherein a plurality of product calibres is arranged on the feeding unit of the slicing machine, the plurality of product calibres is fed simultaneously by the feeding unit along the feeding direction to the cutting device and is sliced by the cutting device.

14. The method according to claim 13, wherein for each of the plurality of product calibres, one or more last slices are cut with either the reduced slice thickness or the enlarged slice thickness, wherein the reduced slice thickness and/or the enlarged slice thickness are/is determined in such a way that each of the plurality of product calibres is substantially cut down to the preset end-piece length.

15. A slicing machine for slicing food products, comprising:
a feeding unit configured to supply at least one product calibre along a feeding direction;
a cutting device configured to slice the at least one product calibre into slices;
a portioning unit configured to form portions from the slices cut by the cutting device, wherein each portion comprises one or more slices; and
a control unit configured to control at least the feeding unit, the cutting device, and the portioning unit;
wherein the slicing machine is configured to carry out the method according to claim 1.

16. The slicing machine according to claim 15, wherein the slicing machine further comprises a length measuring unit configured to determine a length of at least one product calibre before and/or during a slicing operation of the slicing machine.

17. The slicing machine according to claim 15, wherein
the slicing machine further comprises a gripper unit with at least one gripper, wherein the at least one gripper is configured to grip the at least one product calibre at its end facing away from the cutting device,
and/or
the slicing machine further comprises a conveying unit configured to convey the formed portions along a conveying direction.

18. The slicing machine according to claim 15, wherein the slicing machine is designed as a single-track or multi-track slicing machine.

19. A slicing machine for slicing food products, comprising:
a feeding unit configured to supply at least one product calibre along a feeding direction;
a cutting device configured to slice the at least one product calibre into slices so that the at least one product calibre is sliced at least in sections with a preset slice thickness, but at most up to a preset end-piece length;
a portioning unit configured to form portions from the slices cut by the cutting device, wherein each portion comprises one or more slices; and
a control unit configured to control at least the feeding unit, the cutting device, and the portioning unit;
wherein the control unit is operable to control the cutting device such that, before an end of slicing the at least one product calibre, one or more last slices with a reduced slice thickness, which is less than the preset slice thickness, or an enlarged slice thickness, which is greater than the preset slice thickness, are sliced, wherein the reduced slice thickness and/or the enlarged slice thickness are/is determined by the control unit in such a way that the at least one product calibre is sliceable down to the preset end-piece length.

20. The slicing machine according to claim 19, wherein the reduced slice thickness and/or the enlarged slice thickness are/is determined by the control unit in such a way that the at least one product calibre is sliceable down to substantially or exactly the preset end-piece length.
